(19) United States
(12) Patent Application Publication
(10) Pub. No.: US 2010/0021417 A1
(43) Pub. Date: Jan. 28, 2010

(54) ACETATE-CONTAINING MATING DISRUPTANT AND MATING DISRUPTION METHOD USING THE SAME

(75) Inventors: Kinya Ogawa, Tokyo (JP); Tatsuya Hojo, Niigata-ken (JP); Takehiko Fukumoto, Niigata-ken (JP)

Correspondence Address: BEEM PATENT LAW FIRM, 53 W. JACKSON BLVD., SUITE 1352, CHICAGO, IL, 60604-3787, US

(73) Assignee: SHIN-ETSU CHEMICAL CO., LTD., Tokyo (JP)

(21) Appl. No.: 12/507,498

(22) Filed: Jul. 22, 2009

(30) Foreign Application Priority Data
Jul. 24, 2008 (JP) 2008-190700

(51) Int. Cl. A01N 25/00

(52) U.S. Cl. 424/84

(57) ABSTRACT

Provided are a mating disruptant having an improved mating disruption effect against pest insects. Specifically, provided is a mating disruptant for the control of pest insects whose natural sex pheromone composition is substantially free of an alcohol and comprises one or more acetates, the disruptant comprising the one or more acetates and an alcohol or alcohols which can be derived from the one or more acetate, wherein an amount of each of the alcohol or alcohols is from 0.5 to 10% by weight relative to an amount of each deriving acetate; and a mating disruption method using the mating disruptant. The alcohol which can be derived from the acetate is an alcohol obtainable by hydrolysis of the acetate and means an alcohol component of the ester derived from an acid and the alcohol.

### CROSS-REFERENCE TO RELATED APPLICATIONS

This application claims the benefit of priority from Japanese patent application No. 2008-190700, filed Jul. 24, 2008.

### BACKGROUND OF THE INVENTION

1. Field of the Invention

The present invention relates to a so-called mating disruption method and a mating disruptant used therefor, wherein the former is a pest control method comprising a step of releasing a sex pheromone substance of a pest insect in a field to disrupt the mating behavior of the pest insect.

2. Description of the Related Art

Mating disruption for the control of a pest insect is carried out by releasing, in the air, an artificially synthesized sex pheromone of a pest inset to be controlled, suspending it in the air, disrupting the communication between males and females of that species for decreasing their mating rate, and thereby controlling the reproduction of the insect pest of next generation. Many of sex pheromones are aliphatic hydrocarbons having a functional group such as acetate, alcohol or aldehyde. An acetate type sex pheromone is particularly abundant among them.

Natural sex pheromone compositions comprising this acetate type pheromone component may comprise no alcohol, an extremely small amount of alcohol, or several percents or more of alcohol. For oriental tea tortrix moth (Homona magnanima), smaller tea tortrix moth (Adoxophyes honmai), summer fruit tortrix moth (Adoxophyes orana fasciata), common cutworm (Spodoptera litura), light brown apple moth (which may hereinafter be abbreviated as LBAM), grapevine moth (which may hereinafter be abbreviated as GVM) and the like, an alcohol generated by hydrolysis of an acetate, which is an inhibitor of attractant, has an attraction blocking effect. Accordingly, a high-purity natural pheromone composition having as small alcohol content as possible has been used as a mating disruptant in the mating disruption method even when it is used as a lure in a pheromone trap. It is very difficult to industrially remove the alcohol completely so that a natural pheromone composition has inevitably contained 0.1 to 0.5% by weight of alcohol as an impurity in practice.

Particularly in mating disruptants against tea and apple leaf rollers, only (Z)-11-tetradecenyl acetate (which may hereinafter be abbreviated as “Z11-TDA”) which is a common component in the natural sex pheromones has been used conventionally. As the leaf rollers have acquired marked resistance against Z11-TDA, 8 to 30% by weight of (Z)-9-tetradecenyl acetate (which may hereinafter be abbreviated as “Z9-TDA”) relative to an amount of Z11-TDA is added against smaller tea tortrix moth, while 2 to 30% by weight of (Z)-9-dodecenyl acetate (which may hereinafter be abbreviated as “Z9-DDA”) relative to an amount of Z11-TDA is added as a countermeasure against it.

Examples of prior art documents include JP 62-212305A/1987, JP 63-246301A/1988 and JP 06-065007/1994.

### BRIEF SUMMARY OF THE INVENTION

As a result of addition of 8 to 30% by weight of Z9-TDA relative to Z11-TDA, the mating disruptant has recovered its mating disruption effect for pest control. However, the effect is inconsistent. The study of the mating disruptant has revealed that there is a variation in the content of the alcohol ((Z)-9-tetradecenol, which may hereinafter be abbreviated as “Z9-TDOL”) which is contained as an impurity of Z9-TDA, one of the effective components of the mating disruptant. The variation is from 0.1 to 0.5% by weight relative to an amount of Z9-TDA (from 0.02 to 0.12% by weight based on the total weight of the effective components). Because many of alcohols exhibit attraction inhibition effects, the content of alcohols is kept as low as 0.1 to 0.5% by weight relative to the content of corresponding acetates. Accordingly, it has been found that the mating disruption effect particularly in a high population density is reduced.

With a view toward overcoming the above problem, the present invention has been made. An object of the invention is to improve the mating disruption effect by adding, to a sex pheromone composition of a pest being substantially alcohol free and containing one or more acetates, all of the corresponding alcohol or alcohols obtainable by hydrolysis of the one or more acetates, or at least the corresponding alcohol obtainable by hydrolysis of the major acetate. It is sharp contrast with the conventional methods where the extremely restricted amount of the alcohol or alcohols is used.

The present inventors have found that a mating disruptant comprising a sex pheromone composition obtained by adding, to a substantially alcohol-free and acetate-containing sex pheromone composition of a pest, all of the corresponding alcohol or alcohols obtainable by hydrolysis of the one or more acetates, or at least the corresponding alcohol obtainable by hydrolysis of the major acetate in amount of 0.5 to 10% by weight relative to the amount of the acetate, and a mating disruption method using the disruptant are useful for achieving the above object.

More specifically, in the present invention, there are thus provided a mating disruptant to be applied to a pest insect whose natural sex pheromone composition is substantially free of an alcohol and contains one or more acetates, the disruptant comprising the one or more acetates and an alcohol or alcohol which can be derived from the one or more acetates, wherein an amount of each of the alcohol or alcohols is from 0.5 to 10% by weight relative to an amount of each deriving acetate; and a mating disruption method using the mating disruptant. The term “alcohol which can be derived from the acetate” as used herein means an alcohol obtainable by hydrolysis of the acetate and is the alcohol component of the ester derived from an acid and an alcohol.

In the conventional mating disruption method using a mating disruptant comprising mainly an acetate type sex pheromone such as Z11-TDA, it is said that decrease in the effect of the method is inevitable in a high population density because they may mate each other via means other than sex pheromone such as visual perception or contact. However, according to the invention, the pest control effect by the mating disruption becomes stable by specifying the content of the alcohol in the acetate type sex pheromone serving as an effective synergist.

In addition, when the content of the alcohol in the acetate type sex pheromone is adjusted to fall within a predetermined range in advance, even if a mating disruption method performed by using a mating disruptant shows an abnormal disruption ratio by traps, it is possible to start immediately to investigate the other causes of such an abnormal value by omitting a synergist effect of the alcohol. The other causes may include drop of the disruptant on the ground or shortage in the application amount. As a result, a measure for it can be taken quickly.

### DETAILED DESCRIPTION OF THE INVENTION

According to the invention, the mating disruptant comprises one or more acetates which are same as one or more acetates of a natural sex pheromone composition, and an alcohol or alcohols which can be derived from the one or more acetates, wherein an amount of each of the alcohol or alcohols is 0.5 to 10% by weight, more preferably 0.8 to 10% by weight, still more preferably 1 to 6% by weight relative to an amount of each deriving acetate.

More specifically, the invention relates to a mating disruptant comprising 0.5 to 5.0% by weight, preferably 0.8 to 3.0% by weight of the derived alcohol relative to the amount of the deriving acetate which constitutes 50 to 100% by weight of the natural sex pheromone composition; a mating disruptant comprising 0.7 to 7.0% by weight, preferably 1.0 to 4.0% by weight of the derived alcohol relative to the amount of the deriving acetate which constitutes 30% by weight or greater but less than 50% by weight of the natural sex pheromone composition; a mating disruptant comprising 1.0 to 8.0% by weight, preferably 1.2 to 5.0% by weight of the derived relative to the amount of the deriving acetate which constitutes 10% by weight or greater but less than 30% by weight of the natural sex pheromone composition; or a mating disruptant comprising 1.5 to 10.0% by weight, preferably 1.5 to 6.0% by weight of the derived alcohol relative to the amount of the deriving acetate which constitutes less than 10% by weight of the natural sex pheromone composition; and a mating disruption method using the mating disruptant.

The term “substantially free of an alcohol” as used herein means not only that the mating disruptant contains no alcohol but also that it may contain an alcohol if the alcohol does not have an attraction activity. For example, when the acetate constitutes from 50 to 100% by weight of the natural sex pheromone composition, the derived alcohol is less than 0.5% by weight relative to the amount of the deriving acetate. When the acetate constitutes 30% by weight or greater but less than 50% by weight of the natural sex pheromone composition, the derived alcohol is less than 0.7% by weight relative to the amount of the deriving acetate. When the acetate constitutes 10% by weight or greater but less than 30% by weight of the natural sex pheromone composition, the derived alcohol is less than 1.0% by weight relative to the amount of the deriving acetate. When the acetate constitutes less than 10% by weight of the natural sex pheromone composition, the derived alcohol is less than 1.5% by weight of the natural sex pheromone composition relative to the amount of the deriving acetate.

The examples in which a mating disruptant comprises an alcohol as a component having no attraction activity, may include (i) a case where a mating disruptant comprises an alcohol which is a precursor of an acetate and the alcohol has remains without becoming the acetate when an acetate sex pheromone is biosynthesized in an insect body, and (ii) a case where a mating disruptant comprises the alcohol produced by hydrolysis of an acetate. Whether the alcohol comprised by the mating disruptant has an attraction activity or not can be determined by using, for example, electroantennogram (EAG) responses. In this measurement method, a minute electrode is inserted into a male antenna excised from a pest insect, and the resulting male antenna is brought into contact with air containing a specific component so that a feeble antenna potential generated from a component having an attraction activity is detected after amplification.

The term “a component having an attraction activity” as used herein means an effective component which a female of a pest insect has for attracting its male and it typically means some or all of the ingredients contained in a natural sex pheromone component.

The acetate comprised by the mating disruptant has no limitation imposed on the kind or the number thereof insofar as it is a sex pheromone. Aliphatic acetate having 10 to 20 carbon atoms is the most suitable. Examples of the acetate include decyl acetate, decenyl acetate, decadienyl acetate, undecyl acetate, undecenyl acetate, dodecyl acetate, dodecenyl acetate, dodecadienyl acetate, tridecyl acetate, tridecenyl acetate, tridecadienyl acetate, tetradecyl acetate, tetradecenyl acetate, tetradecadienyl acetate, hexadecyl acetate, hexadecenyl acetate, hexadecadienyl acetate, octadecyl acetate, octadecenyl acetate and octadecadienyl acetate.

The sex pheromone composition may comprise a sex pheromone other than the above acetate sex pheromone.

The alcohol comprised by the mating disruptant is, for example, the alcohol obtained by hydrolysis of the acetate. Examples of the alcohol include decyl alcohol, decenyl alcohol, decadienyl alcohol, undecyl alcohol, undecenyl alcohol, dodecyl alcohol, dodecenyl alcohol, dodecadienyl alcohol, tridecyl alcohol, tridecenyl alcohol, tridecadienyl alcohol, tetradecyl alcohol, tetradecenyl alcohol, tetradecadienyl alcohol, hexadecyl alcohol, hexadecenyl alcohol, hexadecadienyl alcohol, octadecyl alcohol, octadecenyl alcohol and octadecadienyl alcohol.

The natural sex pheromone composition may contain various ingredients, depending on the kind of the pest insect to be controlled. The ingredients may include an ingredient having a high composition ratio, an ingredient having a low composition ratio, and an ingredient having a medium composition ratio. In general, the ingredient comprised in an amount of 50% by weight or greater may be considered as an ingredient of a high composition ratio, while the ingredient comprised in an amount of less than 10% by weight may be considered as an ingredient of a low composition ratio.

The mating disruptant has no particular limitation imposed on the kind or the number of pest insects to be controlled insofar as it can be used for the mating disruption method. In addition, there is no limitation on crops to which the mating disruptant is applied.

Based on a ratio in a natural sex pheromone composition and a ratio of each insect component in the mating disruptant for controlling one or more kinds of pest insects, the acetate content in the total natural sex pheromone composition is classified into four groups: from 50 to 100% by weight, 30% by weight or greater but less than 50% by weight, 10% by weight or greater but less than 30% by weight, and less than 10% by weight.

When the deriving acetate constitutes 50 to 100% by weight in the total natural sex pheromone composition, a mating disruption method using a mating disruptant comprising 0.5 to 5.0% by weight, preferably 0.8 to 3.0% by weight of the derived alcohol relative to the deriving acetate can bring a good control effect, while a disruption ratio by traps is good or may decrease slightly. When the deriving acetate constitutes 30% by weight or greater but less than 50% by weight in the total natural sex pheromone composition, use of a mating disruptant comprising 0.7 to 7.0% by weight, preferably 1.0 to 4.0% by weight of the derived alcohol relative to the deriving acetate can bring the confirmable effect. When the deriving acetate constitutes 10% by weight or greater but less than 30% by weight in the total natural sex pheromone composition, use of a mating disruptant comprising 1.0 to 8.0% by weight, preferably 1.2 to 5.0% by weight of the derived alcohol relative to the deriving acetate can bring the confirmable effect. When the deriving acetate constitutes less than 10% by weight in the total natural sex pheromone composition, use of a mating disruptant comprising 1.5 to 10.0% by weight, preferably from 1.5 to 6.0% by weight of the derived alcohol relative to the deriving acetate can bring the confirmable effect. More particularly, when the deriving acetate constitutes less than 50% by weight (the acetate is a minor component) in the total natural sex pheromone composition, use of a mating disruptant comprising 1 to 10% by weight of the derived alcohol relative to the deriving acetate may be preferable.

The amount of the alcohol to be added varies depending on the content of the acetate sex pheromone. Although it is presumed to be affected by a release amount of the alcohol from the mating disruptant, details of the reason have not yet been confirmed. In each case, it is not preferable to add the alcohol in an amount exceeding the upper limit because it produces a disruption effect by traps and because of an economic reason. On the other hand, it is not suitable to add the alcohol in an amount below the lower limit because it has less or no influence on the control effect although the reason of which is not known.

The alcohol to be added to the acetate may be desirably the alcohol obtained by hydrolysis of the acetate, but has no particular limitation imposed on the preparation methods thereof insofar as it has the same structure.

The invention can be applied to any pest insects insofar as they have substantially alcohol-free and acetate-containing sex pheromone compositions. They may be preferably pest insects belonging to the families Tortricidae, Noctuidae and Pyralidae. Specific examples may include the family Tortricidae such as oriental tea tortrix moth (Homona magnanima), smaller tea tortrix moth (Adoxophyes honmai) and summer fruit tortrix moth (Adoxophyes orana fasciata), common cutworm (Spodoptera litura), LBAM (Epiphyas postvittana), European Grape Berry Moth (abbreviated as EGBM in the following) (Eupoecilia ambiguella), GVM (Lobesia botrana), dark fruit-tree tortrix (Pandemis heparana), tomato pinworm (Keiferia lycopersicella), peach tree borer (Synanthedon exitiosa), lesser peach tree borer (Synanthedon pictipes) and cherry tree borer (Synanthedon hector).

Some of conventional mating disruptants may contain a trace amount of an alcohol due to the cause in manufacturing an acetate sex pheromone. However, the alcohol is not intentionally added so that it does not limit the invention.

The following are specific examples of the mating disruptant of the invention.

(1) A mating disruptant against oriental tea tortrix moth, smaller tea tortrix moth, apple tortrix (Archips fuscocupreanus), summer fruit tortrix moth, and/or Archips breviplicana Walsingham, the disruptant comprising (Z)-11-tetradecenyl acetate whose content in the sum of acetates is 65 to 85% by weight, (Z)-9-tetradecenyl acetate whose content therein is 10 to 20% by weight, 10-methyl-dodecyl acetate whose content therein is 1 to 3% by weight, (Z)-9-dodecenyl acetate whose content therein is 2 to 20% by weight, 11-dodecenyl acetate whose content therein is 1 to 3% by weight, 0.5 to 5% by weight (Z)-11-tetradecenol relative to the amount of the deriving acetate, 1 to 8% by weight (Z)-9-tetradecenol relative to the amount of the deriving acetate, 1.5 to 10% by weight 10-methyl-dodecanol relative to the amount of the deriving acetate, 1.5 to 10% by weight (Z)-9-dodecenol relative to the amount of the deriving acetate, and 1.5 to 10% by weight 11-dodecenol relative to the amount of the deriving acetate.

(2) A mating disruptant against oriental tea tortrix moth, smaller tea tortrix moth, apple tortrix (Archips fuscocupreanus), summer fruit tortrix moth and/or Archips breviplicana Walsingham, the disruptant comprising (Z)-11-tetradecenyl acetate whose content in the sum of acetates is 50 to 65% by weight, (Z)-9-tetradecenyl acetate whose content therein is 5 to 20% by weight, 10-methyl-dodecyl acetate whose content therein is 0.5 to 3% by weight, (Z)-9-dodecenyl acetate whose content therein is 15 to 29% by weight, 11-dodecenyl acetate whose content therein is 5 to 9% by weight, 0.5 to 5% by weight (Z)-11-tetradecenol relative to the amount of the deriving acetate, 1 to 8% by weight (Z)-9-tetradecenol relative to the amount of the deriving acetate, 1.5 to 10% by weight 10-methyl-dodecanol relative to the amount of the deriving acetate, 1 to 8% by weight (Z)-9-dodecenol relative to the amount of the deriving acetate, and 1.5 to 10% by weight 11-dodecenol relative to the amount of the deriving acetate.

(3) A mating disruptant against common cutworm, the disruptant comprising (Z,E)-9,11-tetradecadienyl acetate whose content in the sum of acetates is from 80 to 99% by weight, (Z,E)-9,12-tetradecadienyl acetate whose content therein is from 1 to 20% by weight, 0.5 to 5% by weight (Z,E)-9,11-tetradecadienol relative to the amount of the deriving acetate, and 1 to 10% by weight (Z,E)-9,12-teteradecadienol relative to the amount of the deriving acetate.

(4) A mating disruptant against LBAM, the disruptant comprising E-11-tetradecenyl acetate whose content in the sum of acetates is from 90 to 99% by weight, (E,E)-9,11-tetradecadienyl acetate whose content therein is from 1 to 10% by weight, 0.5 to 5% by weight (E)-11-tetradecenol relative to the amount of the deriving acetate, and 1.5 to 10% by weight (E,E)-9,11-tetradecadienol relative to the amount of the deriving acetate.

(5) A mating disruptant against EGMB, the disruptant comprising (Z)-9-dodecenyl acetate whose content in the sum of acetates is from 85 to 100% by weight, (Z)-11-tetradecenyl acetate whose content therein is from 0 to 15% by weight, 0.5 to 5% by weight (Z)-9-dodecenol relative to the amount of the deriving acetate, and 1 to 10% by weight (Z)-11-tetradecenol relative to the amount of the deriving acetate.

(6) A mating disruptant against GVM, the disruptant comprising (E,Z)-7,9-dodecadienyl acetate, and 0.5 to 5% by weight (E,Z)-7,9-dodecadienol relative to the amount of the acetate.

The invention is not limited to them. If a considerable amount of the alcohol derived from the acetate is comprised by the disruptant owing to the content of the acetate, the disrupant may be a complex disruptant against two or more kinds of pest insects.

The amount of acetate or acetates comprised by a mating disruptant can be determined based on a composition of the natural sex pheromone. The acetate having the highest content in the natural sex pheromone can be typically selected as the highest content component (major component) of the mating disruptant. However, the acetate having the second highest content in the natural sex pheromone may be selected as the highest content component (major component) of the mating disruptant when the second highest content component is preferably 20 to 80% by weight, more preferably 40 to 80% by weight relative to the amount of the highest content component in the natural sex pheromone. In this case the composition of the mating disruptant can be selected as if the natural sex pheromone having the highest and the second highest content acetates replaced by the second highest and the highest content acetates, respectively, were present.

The content of the major component acetate in the mating disruptant of the present invention can be the same as the content of the acetate of the conventional mating disruptant comprising, as the major component, the highest content acetate in the natural sex pheromone. When a natural sex pheromone contains two or more acetates, the acetate or acetates other than the major component acetate may be added to a mating disruptant, keeping the weight ratio or ratios of the acetate or acetates other that the major component acetate to the major component acetate preferably almost same as the weight ratio or ratios of the acetate or acetates other that the highest content acetate to the highest content acetate in the natural sex pheromone. It is because the mating disruptant of the present invention has nothing different from the conventional mating disruptant except that an alcohol or alcohols which are substantially absent in the later because of attraction-inhibiting effect are present in the former.

The mating disruptant targeted against two or more species of pest insects can comprise a common component as a major component.

A stabilizer such as an antioxidant or a UV absorber, or colorant can be contained by 20% by weight or less in the mating disruptant of the present invention.

The mating disruptant can be provided in any form insofar as it is a container or a carrier capable of retaining the acetate sex pheromone and an alcohol obtainable by hydrolysis of the acetate and releasing them gradually. It may be preferably in form of a tube, a capsule, an ampoule or a bag. Of these, the tube may be the most suitable because it can release the sex pheromone uniformly for a long period of time. The tube having an inner diameter of from 0.5 to 2.0 mm and thickness of from 0.2 to 1.0 mm can keep releasing the disruptant at an appropriate rate.

The material of the container may be is preferably a polyolefin polymer. Examples of it may include polyolefins such as polyethylene and polypropylene, and copolymers containing 80% by weight or greater of ethylene such as ethylene-vinyl acetate copolymer and ethylene-acrylate copolymer. A container comprising such a material can let a sex pheromone penetrate and the like through the material and release the sex pheromone and the like at an appropriate rate outside the plastic membrane. The material may also be biodegradable polyester or polyvinyl chloride.

The container in the above-mentioned form may have one or more compartments for enclosing therein a disruptant solution. When it has two or more compartments, their inner diameters or thicknesses may be different from each other. In addition, the disruptant solution may be enclosed in at least one compartment.

In a container having one or more compartments, an amount of the mating disruptant placed in each compartment may be variable depending on a release period, volatility of the sex pheromone substance, affinity with the material of compartment, and others. The amount of the mating disruptant placed in each compartment may be preferably 50 to 400 mg, more preferably 150 to 300 mg.

Even if the mating disruptants satisfy the above conditions, the mating disruptants which require a special place for handling them or have an adverse effect on the environment are not preferred.

### EXAMPLES

The present invention will hereinafter be described by Examples. However, it should not be construed that the invention is limited to or by them.

### Preparation of Mating Disruptant

A polymer container made of a polyethylene tube having a predetermined inner diameter and thickness was manufactured by extrusion. Then, an intended sex pheromone composition was prepared by controlling alcohol content, corresponding to the content of acetate in a sex pheromone composition. After the resulting solution was poured from one end of the polyethylene tube, both ends of the tube were heated by high frequency waves and presseor melting and sealing. The melted portions were cut to yield a sustained release mating disrupant for the test trial. The mating disruptants thus obtained were placed at equal intervals in a field subjected to pest insect control so as to release a necessary amount of the sex pheromone substance.

### Disruption Ratio by Traps

A disruption ratio by traps can relatively easily estimate a mating disruption effect and is represented by the following equation:

Disruption ratio by traps (%)={(the number of insects captured in a plot not subjected to pheromone treatment−the number of insects captured by pheromone treatment)/(the number of insects captured in a plot not subjected to pheromone treatment)}×100.

Accordingly, the higher ratio is likely to mean a higher mating disruption effect.
The number of Larvae, Percentage of Damaged Fruits, Percentage of Damaged Bunches, and Percentage of Damaged Stems

The number of larvae, percentage of damaged fruits, or percentage of damaged bunches can be used depending on the kind of a crop, as an estimate of a mating disruption effect other than the disruption ratio by traps.

The effect on tea leaves is typically expressed by the number of larvae per unit area (/m²).

The effect on fruits is expressed by the percentage of damaged fruits represented by the following equation: {(the number of damaged fruits)/(the number of fruits surveyed)}×100. In particular, in grapes, the percentage of damaged bunches represented by {(the number of damaged bunches)/(the number of bunches surveyed)}×100 is one of the criteria for judging the effect. The percentage of damaged stems represented by the following equation: {(the number of damaged stems)/(the number of stems surveyed)}×100 is also used.

### Example 1

When a mating disruption method against LBAM was performed using a conventional mating disruptant, the number of LBAM caught in a pheromone trap tended to be not greater than 1 per day. Because an amount of the alcohol (E11-TDOL) was 0.2 to 0.5% by weight in the total composition of the mating disruptant, such a range of alcohol was said to have a high pest control effect. However, the effect of an organophosphorus agent such as azinphos-methyl decreased probably because of resistance thereto and pest population density became high in some areas. Taking the above into consideration, comparison tests at high and low population density areas were performed by increasing amounts of alcohol. In an apple field, 500 tubes/ha of mating disrupants, each tube having a length of 200 mm and containing 200 mg of stock solution having the following composition, HBMCBT (2-(2′-hydroxy-3′-tert-buty-5′-methyphenyl)-5-chlorobenztriazol) and BHT (2,6-ditert-buty-4-methylphenol), were placed on November 16. In each test plot, two pheromone traps were placed and a disruption ratio by traps was measured. In addition, 500 apples were observed for pest damage at the time of harvest.

TABLE 1

| | | low population density area | | | high population density area | | |
|---|---|---|---|---|---|---|---|
| | | | low | high | | low | high |
| Test Plot | | insecticide | alcohol | alcohol | insecticide | alcohol | alcohol |
| composition (wt %) | E11-TDA | — | 68.1 | 67.1 | — | 68.0 | 67.1 |
| | EE9,11-TDDA | — | 5.6 | 5.6 | — | 5.6 | 5.6 |
| | Z11-TDA | — | 23.1 | 22.8 | — | 23.1 | 22.8 |
| | E11-TDOL | — | 0.2 | 1.1 | — | 0.2 | 1.1 |
| | EE9,11- | — | <0.01 | 0.2 | — | <0.01 | 0.2 |
| | TDDOL | | | | | | |
| wt ratio (%) | E11- | — | 0.3 | 1.6 | — | 0.3 | 1.6 |
| | TDOL/E11- | | | | | | |
| | TDA | | | | | | |
| | EE- | — | <0.2 | 3.6 | — | <0.2 | 3.6 |
| | TDDOL/EE- | | | | | | |
| | TDDA | | | | | | |

| | | | | | | |
|---|---|---|---|---|---|---|
| average number | 0.69 | 0.002 | 0.001 | 2.49 | 0.012 | 0.002 |
| captured | | | | | | |
| (number/day/trap) | | | | | | |
| disruption ratio | — | 99.7 | 99.6 | — | 99.5 | 99.9 |
| by traps (%) | | | | | | |
| percentage of | 0.47 | 0.19 | 0.05 | 2.6 | 3.1 | 0.09 |
| damaged fruits (%) | | | | | | |

In Table 1, acetates and alcohols are indicated by the following abbreviations:
E11-TDA: (E)-11-tetradecenyl acetate
EE9,11-TDDA: (E,E)-9,11-tetradecadienyl acetate
Z11-TDA: (Z)-11-tetradecenyl acetate
E11-TDOL: (E)-11-tetradecenol
EE9,11-TDDOL: (E,E)-9,11-tetradecadienol

Although the acetate sex pheromone is an effective component against LBAM, the corresponding alcohol is not an effective component. However, when a pest population density is high, a mating disruptant having a higher alcohol content has a higher pest control effect although the reason for that is not known. The ratio of the alcohol (E11-TDOL) to the acetate (E11-TDA) which constitutes more than 50% by weight in the total natural sex pheromone composition was preferably 1.6% rather than 0.3%. The ratio of the alcohol (E,E-9,11-TDDOL) to the acetate (E,E-9,11-TDDA) which constitutes less than 10% by weight in the total natural sex pheromone composition was preferably 3.6% rather than 0.2%.

### Example 2

In Europe, particularly northern Europe, EGBM has been a main pest insect of grapes. The second generation of it does real damage to grapes so that insecticides have conventionally been used for the control of the second generation. Mating disruptants have therefore been used also against the second or later generation. However, they have not yet brought sufficient pest control effects because sex pheromone has a pest control effect reduced as the pest population density increases. Since the mating disruptants were switched from the application against the second or later generation to the application against the first generation with a low population density, stable results has been obtained. In recent years, due to global warming, districts having a high population density of the over-wintering generation have appeared. Mating disruption tests were performed using mating disruptants comprising increased amounts of alcohol. The amount of alcohol was increased from 0.2 to 0.5% by weight, which is conventionally present as an impurity, to 0.7 to 5% by weight. In a grape field, 500 tubes/ha of mating disruptants, each tube having a length of 200 mm and containing 200 mg of stock solution having the following composition, HOBP (2-hydroxy-4-octoxybenzopheone) and BHT (2,6-ditert-buty-4-methylphenol) were placed. In each test plot, a pheromone trap was installed and a disruption ratio by traps was measured. In addition, a percentage of damaged bunches by the second generation was measured on June 30.

TABLE 2

| | | Test Plot | | | |
|---|---|---|---|---|---|
| | | | 2 | | |
| | | 1 | Comp. Ex. | 3 | 4 |
| composition | Z9-DDA | 90.2 | 93.1 | 92.8 | 83.6 |
| (wt %) | Z9-DDOL | 1.8 | 0.1 | 0.6 | 8.2 |
| weight ratio | Z9-DDOL/Z9-DDA | 2.0 | 0.1 | 0.6 | 8.8 |
| (%) | | | | | |

| | | | | |
|---|---|---|---|---|
| disruption ratio by traps (%) | 98.8 | 98.0 | 98.5 | 92.1 |
| percentage of damaged bunches % | 0.3 | 3.4 | 1.2 | 0.6 |

In Table 2, an acetate and corresponding alcohol are indicated by the following abbreviations:
Z9-DDA: (Z)-9-dodecenyl acetate
Z9-DDOL: (Z)-9-dodecenol

As in Test Plot 2, when the weight ratio of the alcohol (Z9-DDOL) to the main component (Z9-DDA) which constitutes more than 50% by weight in the total natural sex pheromone composition is not greater than 0.5% (0.1% in Test Plot 2), the disruption ratio by traps is high, but the pest control effect is not achieved. On the other hand, as in Test plot 4, when the weight ratio of the alcohol (Z9-DDOL) to the main component (Z9-DDA) which constitutes more than 50% by weight in the total natural sex pheromone composition is not less than 5.0% (8.8% in Test Plot 4), the pest control effect can be achieved, but the attraction blocking ratio lowers. As in Test Plot 1 or 3, when the weight ratio of the alcohol (Z9-DDOL) to the acetate (Z9-DDA) is in the range of from 0.5 to 5.0%, both the disruption ratio by traps and the pest control effect are high. Even if the weight ratio of the alcohol to the acetate is in the range, however, when it is 0.6% and close to the lower limit as in Test Plot 3, a percentage of damaged bunches shows a slight increase so that the weight ratio of the alcohol to the acetate is preferably near the center of the range, for example, from 1.0 to 3.0%.

### Example 3

Mating disruption tests against GVM, a main pest insect of grapes comparable to EGBM in Europe, was performed in a similar manner to those of EGBM. In a grape field, 500 tubes/ha of mating disruptants, each tube having a length of 200 mm and containing 210 mg of stock solution having the following composition, HBMCBT (2-(2′-hydroxy-3′-tert-butyl-5′-methylphenyl)-5-chlorobenztriazol) and BHT (2,6-ditert-buty-4-methyphenol) were placed on March 23. In each test plot, a pheromone trap was installed and a disruption ratio by traps was measured. In addition, a percentage of damaged bunches by the second generation was measured on June 28.

TABLE 3

| | | Test Plot | | | |
|---|---|---|---|---|---|
| | | | 2 | | |
| | | 1 | Comp. Ex. | 3 | 4 |
| composition | E7Z9-DDDA | 85.6 | 86.2 | 83.5 | 80.1 |
| (wt %) | E7Z9-DDDOL | 1.5 | 0.2 | 4.0 | 7.8 |
| weight ratio | E7Z9-DDDOL/E7Z9- | 1.8 | 0.2 | 4.8 | 9.7 |
| (%) | DDDA | | | | |

| | | | | |
|---|---|---|---|---|
| disruption ratio by traps (%) | 98.5 | 97.7 | 96.4 | 90.5 |
| percentage of damaged bunches (%) | 0.4 | 3.7 | 0.2 | 0.5 |

In Table 3, the acetate and corresponding alcohol are indicated by the following abbreviations.
E7Z9-DDDA: (E,Z)-7,9-dodecadienyl acetate
E7Z9-DDDOL: (E,Z)-7,9-dodecadienol

As in Test Plot 2, when the weight ratio of the alcohol (E7Z9-DDDOL) to the main component (E7Z9-DDDA) which constitutes more than 50% in the total natural sex pheromone composition is not greater than 0.5% (0.2% in Test Plot 2), the disruption ratio by traps is high, but the control effect is not achieved. On the other hand, as in Test Plot 4, when the weight ratio of the alcohol (E7Z9-DDDOL) to the main component (E7Z9-DDDA) is 5.0% or greater (9.7% in Test Plot 4), the control effect can be achieved but the disruption ratio by traps lowers. As in Test Plot 1 or 3, when the weight ratio of the alcohol (E7Z9-DDDOL) to the acetate (E7Z9-DDDA) is in the range of 0.5 to 5.0%, both the disruption ratio by traps and the pest control effect are high. Even if the weight ratio of the alcohol to the acetate is in the range, however, when it is 4.8% and close to the upper limit as in Test plot 3, a disruption ratio by traps shows a slight increase. The weight ratio of the alcohol to the acetate is preferably near the center of the range, for example, 0.7 to 3.0% by weight.

### Example 4

Mating disruption tests against common cutworm, a pest insect of vegetables, were performed. In a field of Welsh onion, 100 tubes per 10 ares of mating disruptants, each tube having a length of 200 mm and containing 160 mg of stock solution having the following composition, HBMCBT (2-(2′-hydroxy-3′-tert-butyl-5′-methylphenyl)-5-chlorobenztriazol) and BHT (2,6-ditert-buty-4-methylphenol) were placed on August 20. In each test plot, a pheromone trap was installed and a disruption ratio by traps was measured. In addition, a percentage of damaged stems were measured on September 26.

TABLE 4

| | | Test Plot | | | |
|---|---|---|---|---|---|
| | | | 2 | 3 | |
| | | 1 | Comp. Ex. | Comp. Ex. | 4 |
| comp. | Z9E11-TDDA | 80.2 | 79.8 | 81.0 | 80.6 |
| (wt %) | Z9E12-TDDA | 8.7 | 9.1 | 8.8 | 8.9 |
| | Z9E11-TDDOL | 1.6 | 0.3 | 0.2 | 4.3 |
| | Z9E12-TDDOL | 0.18 | 0.03 | 0.19 | 0.18 |
| wt ratio | Z9E11-TDDOL/Z9E11- | 2.0 | 0.4 | 0.2 | 5.3 |
| (%) | TDDA | | | | |
| | Z9E12-TDDOL/Z9E12- | 2.1 | 0.3 | 2.2 | 2.0 |
| | TDDA | | | | |

| | | | | |
|---|---|---|---|---|
| disruption ratio by traps (%) | 99.4 | 97.3 | 98.5 | 92.2 |
| percentage of damaged stems (%) | 0.3 | 2.5 | 1.2 | 0.4 |

In Table 4, acetates and alcohols are indicated by the following abbreviations.
Z9E11-TDDA: (Z,E)-9,11-tetradecadienyl acetate
Z9E12-TDDA: (Z,E)-9,12-tetradecadienyl acetate
Z9E11-TDDOL: (Z,E)-9,11-tetradecadienol
Z9E12-TDDOL: (Z,E)-9,12-tetradecadienol

As in Test Plot 2, when the weight ratio of the alcohol (Z9E11-TDDOL) to the main component (Z9E11-TDDA) which constitutes more than 50% by weight in the total natural sex pheromone composition is not greater than 0.5% (0.4% in Test Plot 2), the disruption ratio by traps is high, but the control effect is not achieved. On the other hand, as in Test Plot 4, when the weight ratio of the alcohol (Z9E11-TDDOL) to the main component (Z9E11-TDDA) is 5.0% or greater, the pest control effect can be achieved, but the disruption ratio by traps lowers. As in Test plot 1, when the weight ratios of the alcohols to the acetates are in the range of from 0.5 to 5.0%, both the disruption ratio by traps and the control effect are high. On the other hand, in Test Plot 3, the disruption ratio by traps and the number of damaged stems are slightly lowered. Accordingly, all of the ratios of the alcohols to the acetates are preferably near the center of the above range.

### Example 5

Partitions having a height of 60 cm were placed between fields of 20 ares to prevent an alcohol from transferring to an adjacent field. Tests for the mating disruption method were performed using mating disruptants having different alcohol contents against oriental tea tortrix. The alcohol and acetate contents of the mating disruptants applied to each test plot are shown in Table 2. Each mating disruptant in form of a narrow polyethylene tube having a length of 200 mm contained 360 mg of effective component, and BHT (2,6-ditert-buty-4-methylphenol). On March 26, 250 tubes per 10 ares were placed. At the same time, a pheromone trap was installed at the center of each plot and disruption ratios by traps of the first and the second generations were measured. The number of larvae of the first generation and the number of larvae of the second generation were counted on June 13 and on July 26, respectively, at 20 points in each plot by using a 30 cm×30 cm frame.

TABLE 5

| Test Plot | | | | |
|---|---|---|---|---|
| 1 | 2 | 3 | 4 | Control Plot |

| | | | | | |
|---|---|---|---|---|---|
| composition (wt %) | Z11-TDA | 48.5 | 49.0 | 43.4 | 49.1 |
| | Z9-TDA | 13.4 | 13.5 | 13.0 | 13.6 |
| | 10Me-DDA | 1.3 | 1.4 | 1.4 | 1.3 |
| | Z9-DDA | 15.6 | 15.8 | 16.0 | 15.8 |
| | 11-DDA | 5.7 | 5.9 | 5.8 | 5.8 |
| | Z11-TDOL | 0.71 | 0.29 | 3.20 | 0.44 |
| | Z9-TDOL | 0.30 | 0.29 | 0.29 | 0.28 |
| | 10Me-DDOL | 0.023 | 0.022 | 0.027 | 0.023 |
| | Z9-DDOL | 0.23 | 0.24 | 0.22 | 0.25 |
| | 11-DDOL | 0.112 | 0.110 | 0.103 | 0.104 |
| weight ratio (%) | Z11-TDOL/Z11-TDA | 1.5 | 0.6 | 7.4 | 0.9 |
| | Z9-TDOL/Z9-TDA | 2.2 | 2.1 | 2.2 | 2.1 |
| | 10Me-DDOL/10Me-DDA | 1.8 | 1.6 | 1.9 | 1.8 |
| | Z9-DDOL/Z9-DDA | 1.5 | 1.5 | 1.4 | 1.6 |
| | 11-DDOL/11-DDA | 2.0 | 1.9 | 1.8 | 1.8 |

| | | | | | |
|---|---|---|---|---|---|
| disruption ratio by traps | 100 | 99.8 | 91.2 | 100 | captured |
| of the first generation (%) | | | | | no. 2148 |
| disruption ratio by traps | 99.9 | 99.7 | 90.8 | 100 | captured |
| of the second generation (%) | | | | | no. 3543 |
| no. of larvae of the first | 0.0 | 0.4 | 0.0 | 0.3 | 1.4 |
| generation (no./m²) | | | | | |
| no. of larvae of the second | 0.1 | 7.8 | 0.3 | 2.2 | 6.9 |
| generation (no./m²) | | | | | |

In Table 5, acetates and alcohols are indicated by the following abbreviations:
Z11-TDA: (Z)-11-tetradecenyl acetate
Z9-TDA: (Z)-9-tetradecenyl acetate
10Me-DDA: 10-methyl-dodecyl acetate
Z9-DDA: (Z)-9-dodecenyl acetate
11-DDA: 11-dodecenyl acetate
Z11-TDOL: (Z)-11-tetradecenol
Z9-TDOL: (Z)-9-tetradecenol
10Me-DDOL: 10-methyl-dodecanol
Z9-DDOL: (Z)-9-dodecenol
11-DDOL: 11-dodecenol

In Test Plot 2, when the weight ratio of the alcohol (Z11-TDOL) to the acetate (Z11-TDA) which constitutes no less than 30% by weight but less than 50% by weight in the total natural sex pheromone composition is not greater than 0.6%, a pest control effect of the first generation was recognized but weak, causing an increase in the density of the second generation. Accordingly, the pest control effect of the second generation is inferior to that in a conventional control plot shown for a control experiment. In Test Plot 4, when the ratio of the alcohol (Z11-TDOL) to the acetate (Z11-TDA) was no less than 0.7% but less than 1.0%, the pest control effect was recognized but insufficient. On the other hand, in Test Plot 3, when the ratio of the alcohol (Z11-TDOL) to the acetate (Z11-TDA) was more than 7%, the pest control effect was recognized. However, it was not preferable because the disruption ratio by traps was extremely reduced so that it was impossible to use the disruption ratio by traps for evaluation of a mating disruption method.

### Example 6

Partitions having a height of 60 cm were placed between fields of 10 ares to prevent an alcohol from transferring to an adjacent field. Tests of the mating disruption method were performed using mating disruptants having different alcohol contents against smaller tea tortrix. The alcohol and acetate contents of the mating disruptants placed in each test plot are shown in Table 6. Each mating disruptant in form of a small polyethylene tube having a length of 200 mm contained 360 mg of effective component, and BHT (2,6-ditert-buty-4-methylphenol). On March 23 to 24, 250 tubes per 10 ares were placed. At the same time, a pheromone trap was installed at the center of each plot and disruption ratios by traps of the first and the second generations were measured. The number of larvae of the first generation and the number of larvae of the second generation were counted on June 12 and on July 25, respectively, at 40 points in each plot by using a 30 cm×30 cm frame. The “Control Plot” is a field having a high density of pest insects in which the number of the pest insects captured by a trap per night is five to ten.

TABLE 6

| | | Test Plot | | | | | | | | |
|---|---|---|---|---|---|---|---|---|---|---|
| | | 1 | | | | | 6 | | | Control |
| | | Comp. Ex. | 2 | 3 | 4 | 5 | Comp. Ex. | 7 | 8 | Plot |
| composition (wt %) | Z11-TDA | 60.2 | 59.8 | 58.7 | 57.1 | 56.6 | 50.7 | 52.4 | 51.1 | |
| | Z9-TDA | 18.3 | 18.2 | 18.0 | 17.2 | 16.5 | 27.4 | 26.1 | 25.2 | |
| | 10Me-DDA | 1.5 | 1.5 | 1.5 | 1.6 | 1.6 | 1.3 | 1.3 | 1.3 | |
| | Z9-DDA | 3.1 | 3.2 | 3.3 | 3.2 | 3.0 | 2.7 | 2.8 | 2.7 | |
| | 11-DDA | 1.5 | 1.6 | 1.6 | 1.5 | 1.6 | 1.4 | 1.3 | 1.3 | |
| | Z11-TDOL | 1.0 | 1.0 | 1.0 | 1.0 | 1.0 | 0.2 | 0.9 | 4.1 | |
| | Z9-TDOL | 0.06 | 0.19 | 0.42 | 0.72 | 1.32 | 0.54 | 0.52 | 0.52 | |
| | 10Me-DDOL | 0.030 | 0.024 | 0.029 | 0.030 | 0.035 | 0.024 | 0.026 | 0.027 | |
| | Z9-DDOL | 0.052 | 0.053 | 0.064 | 0.061 | 0.054 | 0.053 | 0.044 | 0.052 | |
| | 11-DDOL | 0.027 | 0.027 | 0.028 | 0.030 | 0.032 | 0.026 | 0.030 | 0.021 | |
| weight ratio (%) | Z9-TDOL/Z9-TDA | 0.3 | 1.0 | 2.3 | 4.2 | 8.0 | 2.0 | 2.0 | 2.1 | |
| | Z11-TDOL/Z11- | 1.7 | 1.7 | 1.7 | 1.8 | 1.8 | 0.4 | 1.8 | 8.1 | |
| | TDA | | | | | | | | | |
| | 10Me- | 2.0 | 1.6 | 1.9 | 1.9 | 2.2 | 1.8 | 2.0 | 2.1 | |
| | DDOL/10Me-DDA | | | | | | | | | |
| | Z9-DDOL/Z9- | 1.7 | 1.7 | 1.9 | 1.9 | 1.8 | 2.0 | 1.6 | 1.9 | |
| | DDA | | | | | | | | | |
| | 11-DDOL/11-DDA | 1.8 | 1.7 | 1.8 | 2.0 | 2.0 | 1.9 | 2.3 | 1.6 | |

| | | | | | | | | | |
|---|---|---|---|---|---|---|---|---|---|
| disruption ratio by traps | 99.9 | 100 | 100 | 99.8 | 99.4 | 99.9 | 100 | 96.2 | captured |
| of the 1st generation (%) | | | | | | | | | no. 3221 |
| disruption ratio by traps | 99.8 | 100 | 100 | 99.5 | 98.2 | 99.8 | 100 | 94.0 | captured |
| of the 2nd generation (%) | | | | | | | | | no. 3954 |
| no. of larvae of the first | 2.1 | 0.5 | 0.0 | 0.1 | 0.0 | 3.1 | 0.0 | 0.0 | 4.4 |
| generation (no./m²) | | | | | | | | | |
| no. of larvae of the second | 5.6 | 1.4 | 0.0 | 0.0 | 0.0 | 10.5 | 0.1 | 0.3 | 13.3 |
| generation (no./m²) | | | | | | | | | |

In Table 6, acetates and alcohols are indicated by the following abbreviations:
Z11-TDA: (Z)-11-tetradecenyl acetate
Z9-TDA: (Z)-9-tetradecenyl acetate
10Me-DDA: 10-methyl-dodecyl acetate
Z9-DDA: (Z)-9-dodecenyl acetate
11-DDA: 11-dodecenyl acetate
Z11-TDOL: (Z)-11-tetradecenol
Z9-TDOL: (Z)-9-tetradecenol
10Me-DDOL: 10-methyl-dodecanol
Z9-DDOL: (Z)-9-dodecenol
11-DDOL: 11-dodecenol

Even if the mating disruptants containing not only Z11-TDA but also Z9-TDA as an effective component were used to overcome the appearance of the resistance of leaf rollers as described above, there occurred variations in the pest control effect. It was found that the amounts of alcohol contained as an impurity caused variations in pest control effect. Accordingly, in Example 6, tests were performed while changing the weight ratio of Z9-TDOL to Z9-TDA contained in the mating disruptant to 0.3%, 1.0%, 2.3%, 4.2% and 8.0%. Although the disruption ratio by traps of 98.2 or higher was observed in Test Plots 1 to 5, the pest control effect was not observed in Test Plot 1 with the weight ratio of Z9-TDOL to Z9-TDA being 0.3%, while the good pest control was observed in Test Plot 5 with the weight ratio of Z9-TDOL to Z9-TDA being 8.0%.

In Example 6, the effect caused by the addition of Z11-tetradecenol (which may hereinafter be abbreviated as “Z11-TDOL”) to the main component Z11-TDA was also studied. As a result, it was found that in Test Plot 7 with the ratio of Z11-TDOL to Z11-TDA being 1.8%, the disruption ratio by traps was high and the pest control effect was sufficient. It was also found that in Test Plot 6 with the ratio of Z11-TDOL to Z11-TDA being 0.4%, the disruption ratio by traps was high but the pest control effect was inferior. Consequently, it can be understood that a certain amount or more of alcohol is preferable. On the contrary, as observed in Test Plot 8 with the weight ratio of Z11-TDOL to Z11-TDA being 8.1%, Z11-TDA with a large amount of Z11-TDOL results in the remarkably lowered disruption ratio by traps but the high pest control effect.

It has been conventionally said that in an area with high pest population density, a pest control effect is not always good even if a disruption ratio by traps is high. However, the above results have revealed that when a certain range of alcohol is present with an effective component of acetate, the pest control effect is unexpectedly high in spite of a slight reduction in a disruption ratio by traps.

In Test Plot 1 (the ratio of Z9-TDOL to Z9-TDA was 0.3%) or Test Plot 6 (the ratio of Z11-TDOL to Z11-TDA was 0.4%), where the amount of the alcohol constitutes not greater than 1% by weight in the total natural sex pheromone composition and the ratio of the alcohol to the acetate was not greater than 0.5%, the pest control effect was low. As in Test Plot 3, even if the amount of Z9-TDOL is less than 1% by weight (0.42% by weight in Test Plot 3) in the total natural sex pheromone composition, when the ratio of Z9-TDOL to Z9-TDA is slightly high (2.3% in Test Plot 3), a high pest control effect can be expected.

1. A mating disruptant against a pest insect whose natural sex pheromone composition is substantially free of an alcohol and comprises one or more acetates, the disruptant comprising:
the one or more acetates, and
an alcohol or alcohols which can be derived from the one or more acetates,
wherein an amount of each of the alcohol or alcohols is from 0.5 to 10% by weight relative to an amount of each deriving acetate.

2. The mating disruptant according to claim 1, wherein an amount of the alcohol derived from the acetate which constitutes from 50 to 100% by weight of said natural sex pheromone composition is from 0.5 to 5% by weight relative to an amount of the deriving acetate.

3. The mating disruptant according to claim 1, wherein an amount of the alcohol derived from the acetate which constitutes 30% by weight or greater but less than 50% by weight of said natural sex pheromone composition is from 0.7 to 7% by weight relative to an amount of the deriving acetate.

4. The mating disruptant according to claim 1, wherein an amount of the alcohol derived from the acetate which constitutes 10% by weight or greater but less than 30% by weight of said natural sex pheromone composition is from 1.0 to 8% by weight relative to an amount of the deriving acetate.

5. The mating disruptant according to claim 1, wherein an amount of the alcohol derived from the acetate which constitutes less than 10% by weight of said natural sex pheromone composition is from 1.5 to 10% by weight relative to an amount of the deriving acetate.

6. The mating disruptant according to claim 1, wherein said one or more acetates are selected from the group consisting of decyl acetate, decenyl acetate, decadienyl acetate, undecyl acetate, undecenyl acetate, dodecyl acetate, dodecenyl acetate, dodecadienyl acetate, tridecyl acetate, tridecenyl acetate, tridecadienyl acetate, tetradecyl acetate, tetradecenyl acetate, tetradecadienyl acetate, hexadecyl acetate, hexadecenyl acetate, hexadecadienyl acetate, octadecyl acetate, octadecenyl acetate and octadecadienyl acetate.

7. The mating disruptant according to claim 1, wherein said pest insect belongs to the family Tortricidae.

8. A mating disruption method comprising:
administering a mating disruptant as claimed in claim 1 to a pest insect.

9. A pest control method comprising:
releasing a mating disruptant of a pest insect as claimed in claim 1 in a field to disrupt the mating behavior of the pest insect.
